(19) United States
(12) Patent Application Publication
(10) Pub. No.: US 2012/0094625 A1
(43) Pub. Date: Apr. 19, 2012

(54) DETECTING UNAUTHORISED RADIO COMMUNICATIONS DEVICES

(75) Inventors: Christopher Worley, Chifley (AU); Kathryn Maureen Devoy, Conder (AU)

(73) Assignee: Compucat Research Pty Limited, Belconnen (AU)

(21) Appl. No.: 12/600,025

(22) PCT Filed: May 12, 2008
(86) PCT No.: PCT/AU2008/000661

§ 371 Date: Dec. 21, 2011

(30) Foreign Application Priority Data
May 14, 2007 (AU) 2007902548

(51) Int. Cl. H04B 1/18; H04B 1/16

(52) U.S. Cl. 455/293; 455/337

(57) ABSTRACT

A method for detecting unauthorised radio communications devices, the method including the steps of filtering received radio frequency signals into desired signals having a frequency band characteristic of an unauthorised radio communications device and undesired signals having a different frequency band characteristic of an authorised radio communications device, comparing respective levels of the desired and undesired signals with respective predetermined threshold levels, and generating detection signals indicative of the presence of the unauthorised radio communications device only if the desired signals exceed their predetermined threshold level and the undesired signals do not exceed their predetermined threshold level, thereby passively discriminating between the authorised and unauthorised radio communications devices, and interference therebetween.

### FIELD OF THE INVENTION

The present invention relates to detecting unauthorised radio communications devices.

### BACKGROUND OF THE INVENTION

In restricted areas, radio frequency emissions from particular radio communications devices, for example mobile phones, may be unauthorised, while emissions from other devices, for example handheld radios, may be authorised. Detecting unauthorised radio activity is complicated by telecommunications and privacy laws which prohibit active interception of, or interference with, radio frequency emissions. Another problem is spurious detection of unauthorised devices due to radio frequency interference, for example harmonics, from authorised devices.

What is needed is a solution capable of detecting unauthorised radio communications devices by passively discriminating between authorised and unauthorised radio frequency emissions, as well as interference therebetween.

### SUMMARY OF THE INVENTION

According to the present invention, there is provided a method for detecting unauthorised radio communications devices, the method including the steps of filtering received radio frequency signals into desired signals having a frequency band characteristic of an unauthorised radio communications device and undesired signals having a different frequency band characteristic of an authorised radio communications device, comparing respective levels of the desired and undesired signals with respective predetermined threshold levels, and generating detection signals indicative of the presence of the unauthorised radio communications device only if the desired signals exceed their predetermined threshold level and the undesired signals do not exceed their predetermined threshold level, thereby passively discriminating between the authorised and unauthorised radio communications devices, and interference therebetween.

The present invention also provides a detector for detecting unauthorised radio communications devices, the detector having at least two parallel bandpass filters for filtering received radio frequency signals, at least one of the filters passing desired signals having a frequency band characteristic of an unauthorised radio communications device and at least one other filter passing undesired signals having a different frequency band characteristic of an authorised radio communications device, the at least two filters being respectively connected to at least two threshold circuits which respectively compare received levels of the desired and undesired signals with respective predetermined threshold levels, and a logic circuit connected to the at least two threshold circuits to generate detection signals indicative of the presence of the unauthorised radio communications device only if the desired signals exceed their predetermined threshold level and the undesired signals do not exceed their predetermined threshold level, thereby passively discriminating between the authorised and unauthorised radio communications devices, and interference therebetween.

The detector can include an antenna to receive radio frequency signals. The antenna can be followed by a low noise amplifier which feeds the filters in parallel.

The logic circuit can include one or more logic gates. The logic circuit can further include a microprocessor which is programmable to selectively process the desired and undesired signals to suppress spurious detection signals.

The present invention further provides a system for detecting unauthorised radio communications devices, the system including a plurality of the above detectors each monitoring a zone of an area, a computer configured to receive signals from the plurality of detectors, and software executable by the computer to process the received signals to display detections of unauthorised radio communications devices within individual zones of the area.

### BRIEF DESCRIPTION OF THE DRAWINGS

The invention will be further described by way of example only with reference to the accompanying drawings, in which:

FIG. 1 is a flowchart of a method for detecting unauthorised radio communications devices against a background of authorised radio communications devices according to one embodiment of the invention;

FIG. 2 is a block diagram of a detector of one embodiment of the invention;

FIG. 3 is a block diagram of a detection system using networked detectors of FIG. 2; and

FIGS. 4 and 5 are screenshots generated by software of the detection system of FIG. 3.

### DETAILED DESCRIPTION

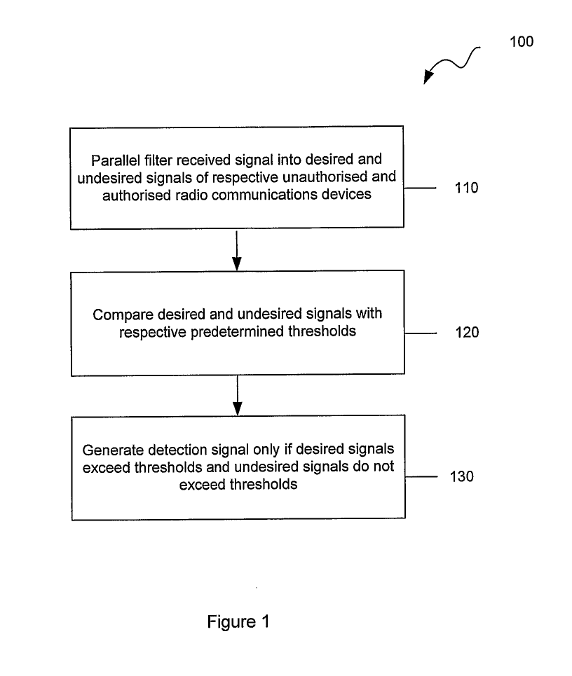

FIG. 1 is a flowchart of a method 100 for detecting unauthorised radio communications devices against a background of authorised radio communications devices according to one embodiment of the invention. The method starts at 110 where a received signal is filtered in parallel into a plurality of filtered signals. At least one of the filtered signals is a desired signal having a selected frequency band which is characteristic of an unauthorised radio communications device, for example a mobile phone. At least one other of the filtered signals is an undesired signal having a different selected frequency band which is characteristic of an authorised radio communications device, for example a handheld radio. Next in step 120, the filtered signals are converted to DC levels proportional to their signal strength, and the respective levels of the desired and undesired signals are compared with respective predetermined threshold levels. Then, in step 130, a detection (or alarm) signal indicative of the presence of the unauthorised radio communications device is generated only if the desired signal exceeds its threshold level and the undesired signal does not exceed its threshold level. This inhibits spurious (or false) detections due to interference of harmonics from the use of the authorised radio communications device. The detection method 100 therefore passively discriminates between authorised and unauthorised radio communications devices in a particular detection area or zone.

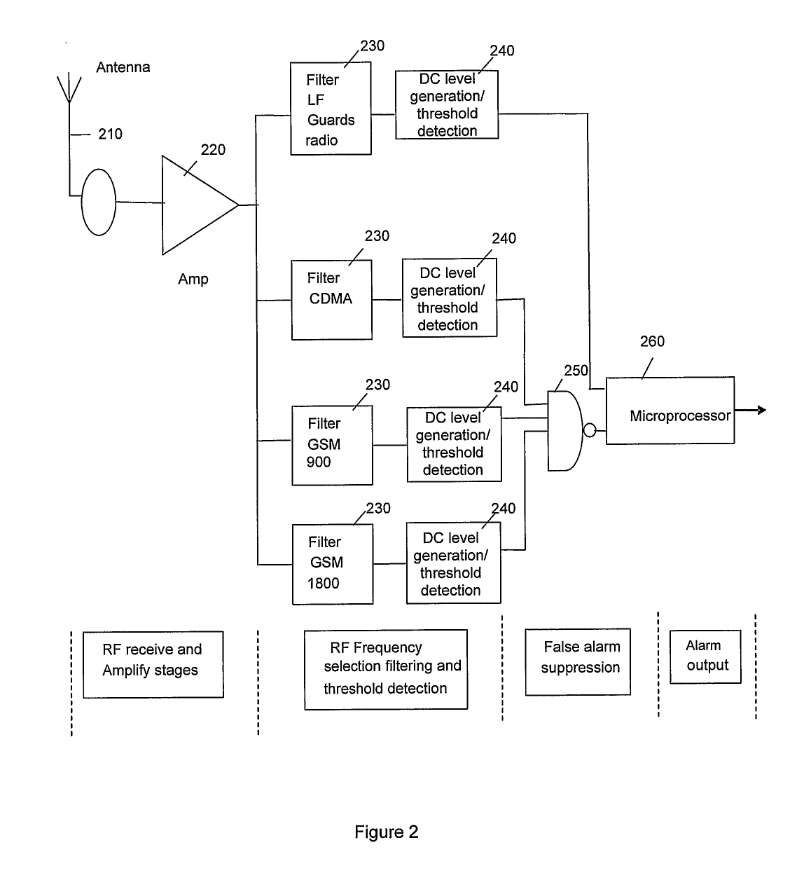

FIG. 2 is a block diagram of one embodiment of a detector 200 for implementing the method 100. The detector 200 includes an antenna 210 followed by a low noise amplifier 220 the output of which is fed to parallel bandpass filters 230 each of which is followed by a threshold circuit 240 which converts the filtered signals to a DC level proportional to its signal strength. Three of the filters 230 are respectively tuned to pass desired signals in the CDMA, GSM 900 and GSM 1800 frequency bands which are characteristic of mobile phones the use of which is unauthorised in the detection area of the detector 200. The remaining filter 230 is tuned to pass undesired signals in a frequency band which is characteristic of handheld radios the use of which is authorised in the reception area of the detector 200. The outputs of the threshold circuits 240 in the desired signal paths are provided to a NAND gate 250 which aggregates their outputs to generate a single detection output. The outputs of the NAND gate 250 and the undesired signal path are provided to a microprocessor 260 which is programmable to selectively process the desired and undesired signals to suppress spurious detection signals due to the use of the authorised radio communications device. For example, the microprocessor 260 is programmed to allow for variances in signal delay times in the various detectors by delaying the final detection output long enough for the various threshold detector signals to stabilise. This prevents false detection spikes where for example, due to differing response times of filter and threshold detector chains, an unauthorised telephony band detection signal arrives is generated slightly in advance of the authorised low frequency band detection signal. In other words, the microprocessor 260 is programmed to provide a short delay to ensure that the use of authorised handheld radios is detected in time to prevent the generation of spurious detections, and to sustain a detection signal to indicate the presence of an unauthorised mobile phone only if any one of the desired signals exceeds their threshold levels and the undesired signal does not exceed its threshold level. This suppresses spurious detections caused by harmonics interference created by the use of the authorised handheld radios.

The relative sensitivity of the detector to different types of authorised and unauthorised radio communications devices and harmonics interference can be adjusted by selectively tuning the bandpass filters and/or selectively varying the threshold levels of the threshold circuits. For example, the threshold levels of the various signals can be set individually as different equipments tend to have different output powers (e.g. GSM phones typically output about 2 W as opposed to hand held radios which output about 5 W). Further, the detector installation process can include setting the sensitivity of the detectors at each band being monitored to optimise performance under local conditions so the threshold levels can be set, thus varying the effective sensitivity of the detector relative to the various bands being monitored.

Embodiments of the invention are not limited to the illustrated circuit components and radio communications devices, but can be alternatively implemented using any conventional analogue, passive radio frequency circuit components to selectively detect and suppress signals which are characteristic of any conventional devices that use any conventional radio frequency communications protocols.

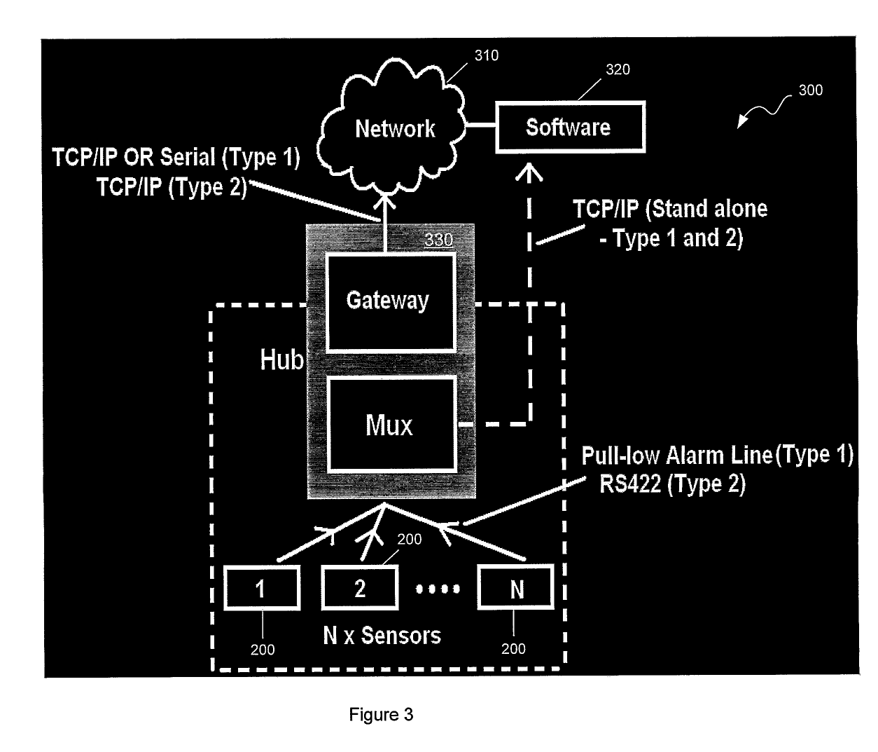

FIG. 3 is a block diagram of a scalable networked client/server detection system 300.

The system 300 includes a plurality of client detectors 200 positioned in a plurality of locations to be monitored. The detectors 200 are communicatively connected via a wired and/or wireless network 310 to a server controller 320. The detectors 200 communicate among themselves and/or via one or more network hubs 330 to the controller 320. DC power is provided to the detectors 200 via the cabling from the network hubs 330, thereby negating the need to provide a power source at each individual detector 200. This has an advantageous impact on infrastructure requirements where a large number of detectors 200 are installed.

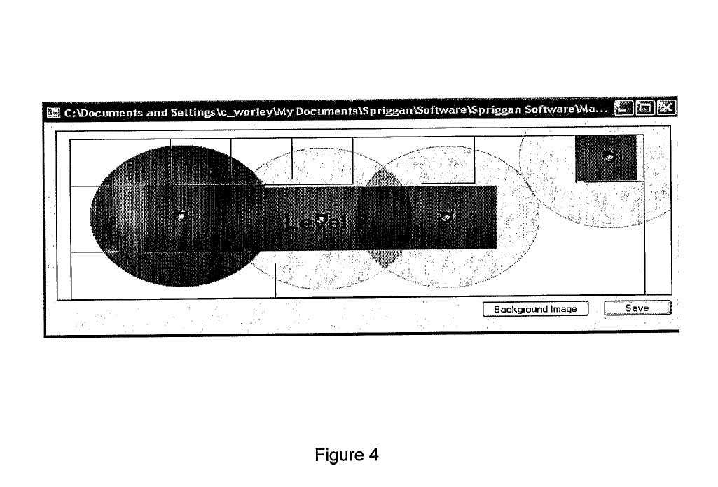

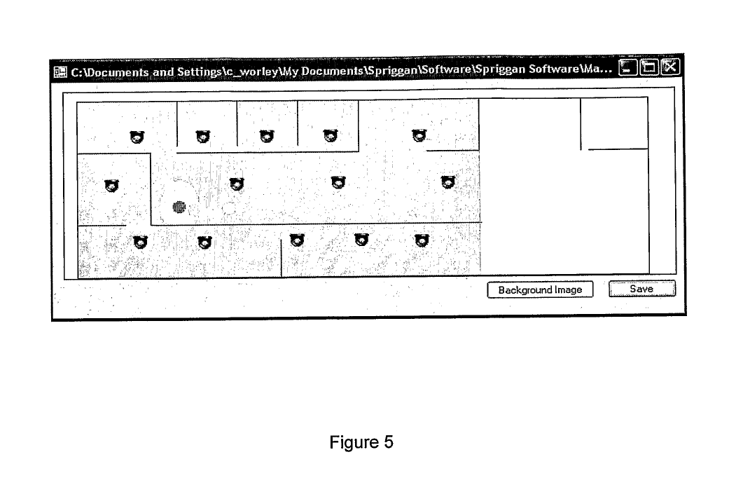

The controller 320 executes server software to process and display information relating to the locations, coverage areas, and detection statuses of respective detectors 200. FIG. 4 is an example screenshot generated by the system software displaying the respective locations of four detectors collectively monitoring a hallway area. The dark-shaded circle indicates that one of the detectors has detected an unauthorised mobile phone, while the light-shaded circles indicate that the other three detectors have not detected unauthorised mobile phones. FIG. 5 is another example screenshot generated by the system software displaying the respective locations of multiple detectors positioned to monitor two-thirds of the area of a building floor. The dark-shaded area indicates the collective detection area of the multiple detectors, while the lighter-shaded elliptical and circular areas indicate multiple detections of an unauthorised mobile phone at different detected activity levels as it moves about the monitored area. The locations of unauthorised mobile phones relative to one or more of the detectors can be determined using conventional techniques, for example, received signal strength, triangulation, etc.

Embodiments of the invention are designed to passively detect the presence of activated radio communications devices in areas where such equipment is banned from use, for example, a secure building where mobile phones are banned. Embodiments of detectors consist of a set of passive radio frequency detection receivers tuned to the specific bandwidths of interest, for example, for mobile phone detection, a set of filters tuned to the relevant bands for GSM and CDMA phones. Unlike the mobile phone jamming systems used in some countries but banned in others, embodiments of the invention do not attempt to interfere with the normal operation of mobile phones, rather they set out to detect and locate any phone that is active within the area of interest. Active jamming systems can cause localised interference to third party use of the radio frequency spectrum beyond the area of interest. In the case of the telephony bands, this could be catastrophic if it interfered with an emergency call. Embodiments of the invention merely passively locate the offending device so that human intervention can be applied to stop the offending use. A further advantage of the passive nature of the embodiments of the invention is that unlike jamming systems, there is no easy way for a mobile telephone user to know whether the detection system of the invention is turned on or not, nor is there any easy way to establish the coverage of the detection system or identify any gaps in that coverage. Accordingly, circumvention of the detection system of the invention is inhibited.

Embodiments of the invention do not attempt to decode the detected radio frequency signal but merely note its presence and activate a detection message to the system server. Thus, while other detection devices seek to identify the mobile phone by number, and in some cases to decode and monitor the conversation or message being sent (which has ramifications in regards to the privacy of the individual and thereby constrains their use in many countries), embodiments of the invention do not go beyond passively locating the device.

The simplicity and low cost of embodiments of the detectors compared to more complex and intrusive alternatives makes it ideal for use in large quantities, for example, on a one detector per cell basis in a prison or remand centre. Embodiments of the detectors can be optimised to monitor any conventional radio communications frequency bands that are selectable during manufacture.

As described above, embodiments of the system generate a detection signal within milliseconds of a target communications device outputting any signal within one of the monitored bands. Thus, the system set up to monitor mobile phone activation, will detect and report the transmission activity associated with the initial log on sequence of the phone as it seeks to acquire a link to the mobile network. Embodiments of the system can be supplied as a set of network hub units capable of having up to N detectors hardwired into them. The hub unit then sends the detection as a TCP/IP signal identifying which hub it is and which detector or detectors are reporting activity. The system can be scaled modularly on a hub by hub basis to provide coverage in both small and large scale applications. All DC power can be provided at the network hubs which can then provide power to each individual detector. This is advantageous in system embodiments where large numbers of detectors are installed.

For example, the invention may be implemented in a prison in which handheld radios are authorised for prison guards, and mobile phones are unauthorised for prisoners. In this implementation, the detectors include a specific guard detection circuit to suppress spurious detections that would be triggered by presence of interference in the bands of interest generated as harmonics resulting, for example, from the use of identified radio frequency communications devices operating outside of the frequency bands of interest, such as the walkie talkie devices carried by prison guards.

Some embodiments of the invention are configured to provide a simple detection alarm while others can be configured to provide additional information such as the specific radio frequency band upon which the unauthorised device is communicating. The embodiment described uses hardwired hubs whereas alternative embodiments of the system could provide a serial network connection capability using protocols such as TCP/IP within each detector allowing the detectors to message the server individually if a suitable network infrastructure is available for direct connection to the detectors.

Embodiments of the invention are advantageous in that they:
are passive and therefore undetectable in operation;
are designed with minimal intelligence built into the detectors;
detect telecommunications activity but not content and therefore do not process the signals beyond that required for detection thereby avoiding privacy issues;
can pinpoint the offending transmitter to within a very small area;
can be made more accurate in location by setting the detectors to be less sensitive;
use detectors that are simple and cheap to manufacture, install and maintain;
will reject false triggering from authorised sources of interference such as walkie talkies, CB radios, etc depending upon the configuration of the detectors;
are not a broadband receiving system but instead listen on specific communications channels thereby avoiding issues with communications regulators unlike some other radio frequency monitoring systems;
are able to ignore other telecommunications activity, such as the output of mobile telephone towers, by restricting the monitoring to specific selected channels;
use analogue monitoring with no data being decoded.

Embodiments of the detection system software can de-conflict multiple detections (for example, caused by the use of multiple detectors relatively close together) and indicate most likely location based upon pattern of detections generated. The software can display the location as graphic or string information.

Embodiments of the system are capable of detecting various radio communications devices that use the radio frequency spectrum to send information, including Bluetooth devices, wireless LAN equipment, mobile terminals, PDAs, personal CB radio transmitters, and any other communications devices wholly or partially reliant upon radio frequency transmissions. The equipment detected depends upon the selection of filter frequencies in the detectors used. The embodiments described above assume detected frequencies are selected to detect the use of mobile telephones; however, it would be equally possible to set the filters to detect other frequencies such as equipment using wireless LAN frequencies.

Embodiments of the system can be implemented as a long-term or permanent installation in a range of sensitive environments such as correctional facilities, detention centres, holding cells, secure buildings, etc, Embodiments can be implemented by installing detectors in the area(s) required to have detection of mobile telephone usage. The detectors can be installed in a covert or an overt manner, and can be deployed and individually tuned to provide overlapping coverage for each area in frequency bands corresponding to the GSM900/1800/1900/CDMA/WCDMA/3G/UMTS mobile phone bands. Embodiments can be tuned to ignore all mobile telephone base station towers, detecting only the radio frequency energy emanating from the mobile phone handset or terminal. Additional authorised radio activity (such as handheld radios) are able to be ignored (if required) or detected also, depending on requirements. Embodiments of the detectors can be designed in such a way that even turning a mobile telephone on or off would trigger the detector—it is not necessary for the user to even attempt to initiate a voice or data call.

Example infrastructure to support a permanent system embodiment of the invention can include the following:
CAT 5 or similar type cabling routed through the building infrastructure to each detector and connecting back to one or more hubs;
a laptop or tower PC, preferably a server with a client PC;
server software and client software;
an appropriate number of detectors;
internal network hub with TCP/IP addresses allocated;
one or more network hubs for transfer of detector output into a TCP/IP address.

Embodiments can therefore become a part of a new or established network, and through TCP/IP, relay all detector detection information through the server, to the client software. The client software can provide immediate notification, call logging, time, type, fault, and map overlay views of mobile telephone activity within the deployed area. Embodiments can therefore provide a true “networked mobile telephone detection” capability. In this fashion, the system is capable of monitoring a large number of detectors over an extremely large area. Additionally, embodiments of the system can transfer information via TCP/IP thereby conferring the ability to remotely monitor unauthorised mobile telephone activity in the chosen controlled area on the other side of the world, if required.

Alternatively, embodiments of the detection system of the invention can be implemented in environments that require only temporary monitoring of mobile telephone activity. For example, portable or deployable embodiments can be used:
in places as board rooms to protect the privacy of meetings;
be used by diplomatic protection teams securing areas for diplomats overseas;
for securing temporary classified areas.

Deployable system embodiments can include the following:
detectors;
CATS or similar cabling;
a laptop controller;
a network hub which will provide power and signal transfer to the laptop controller;
a briefcase type housing for the system.

The functionality of deployable system embodiments is generally similar to the permanent embodiments described above, but the detectors plug into one hub, which then plugs directly into a laptop, with client software only. The deployable system embodiments can be used to detect relatively small areas only, and can be restricted to using a limited number of detectors, for example, no more than ten. Such embodiments are non-intrusive, quickly deployed and provide mobile telephone activity detection in an “operational or tactical” environment.

Embodiments of the system can optionally send and process information about the level or intensity of the detected signal and the frequency band detected thereby allowing better discrimination of the location of the source of the signal.

The invention may also be implemented with detectors having the following properties.
Modular design to allow on site configuration to adapt them to cope optimally with the designated threat environment’. For example this would allow a detector to be modularly configured with sensors to optimally detect signals in the threat wavelengths typical to the environment to be monitored. For example, the detection of mobile telephony frequencies might be supplemented by detection of Bluetooth or computer WiFi frequency detection in some systems but not in others.
Be capable of being ‘daisy chained’ to minimise the amount of installation wiring required, thus rather than having sensors all wired individually to the local hub they might be located along a single power and communications ‘bus’ which would supply each of them with power and bidirectional communications.
Locally analyse the detected signal sufficiently to identify the type of communication device and mode of use (but not the substance or content of the communication itself), and send the results to the central system reducing the bandwidth requirement at the hubs and on the bus.
Support remote or local digital tuning capability to allow on-site optimisation of detection characteristics.
Permit Interaction with RFID type devices/switches.
Provide a directional detection capability to accurately locate emitters by triangulation.
Provide outputs to trigger audio and or visual alerting equipment at/or near the detector.
Provide detection of a wide spectrum of RF communications signals including (but not limited to and depending upon the particular installation) current (and, by modular upgrades, future) mobile telephony bands plus Blue Tooth and WiFi detection.

The central systems software may also have the following functionality.
An easy to use GUI interface.
Remote Web interfacing.
Event logging with a built in back-up capability.
Remote digital tuning of the sensors on a sensor-by-sensor basis.
An API for interaction with other systems (to allow interoperability with other users).

The embodiments have been described by way of example only and modifications are possible within the scope of the claims which follow.

1. A method for detecting unauthorised radio communications devices, the method including the steps of filtering received radio frequency signals into desired signals having a frequency band characteristic of an unauthorised radio communications device and undesired signals having a different frequency band characteristic of an authorised radio communications device, comparing respective levels of the desired and undesired signals with respective predetermined threshold levels, and generating detection signals indicative of the presence of the unauthorised radio communications device only if the desired signals exceed their predetermined threshold level and the undesired signals do not exceed their predetermined threshold level, thereby passively discriminating between the authorised and unauthorised radio communications devices, and interference therebetween.

2. A detector for detecting unauthorised radio communications devices, the detector having at least two parallel bandpass filters for filtering received radio frequency signals, at least one of the filters passing desired signals having a frequency band characteristic of an unauthorised radio communications device and at least one other filter passing undesired signals having a different frequency band characteristic of an authorised radio communications device, the at least two filters being respectively connected to at least two threshold circuits which respectively compare received levels of the desired and undesired signals with respective predetermined threshold levels, and a logic circuit connected to the at least two threshold circuits to generate detection signals indicative of the presence of the unauthorised radio communications device only if the desired signals exceed their predetermined threshold level and the undesired signals do not exceed their predetermined threshold level, thereby passively discriminating between the authorised and unauthorised radio communications devices, and interference therebetween.

3. A detector according to claim 2, further including an antenna to receive radio frequency signals.

4. A detector according to claim 3, wherein the antenna is followed by a low noise amplifier which feeds the filters in parallel.

5. A detector according to claim 2, wherein the logic circuit includes one or more logic gates.

6. A detector according to claim 5, wherein the logic circuit further includes a microprocessor which is programmable to selectively process the desired and undesired signals to suppress spurious detection signals.

7. A system for detecting unauthorised radio communications devices, the system including a plurality of detectors according to claim 2, each monitoring a zone of an area, a computer configured to receive signals from the plurality of detectors, and software executable by the computer to process the received signals to display detections of unauthorised radio communications devices within individual zones of the area.
